(19) United States
(12) Patent Application Publication
(10) Pub. No.: US 2004/0255121 A1
(43) Pub. Date: Dec. 16, 2004

(54) Method and communication terminal device for secure establishment of a communication connection

(76) Inventors: Michael Eckert, Braunschweig (DE); Martin Hans, Hildesheim (DE); Achim Luft, Braunschweig (DE)

Correspondence Address: BELL, BOYD & LLOYD, LLC, P. O. BOX 1135, CHICAGO, IL, 60690-1135, US

(21) Appl. No.: 10/672,335

(22) Filed: Sep. 25, 2003

(30) Foreign Application Priority Data
Sep. 25, 2002 (DE) 102 446 10.5

(51) Int. Cl. H04L 9/00

(52) U.S. Cl. 713/171; 380/257

(57) ABSTRACT

A method is provided for secure establishment of a direct communication connection operating according to a first communication standard between at least a first communication terminal device and a second communication terminal device, wherein for establishment of the direct communication connection, an exchange of keys for encrypting data transferred over the direct communication connection is carried out, the key exchange being performed at least partially via a further switched communication connection operating according to a radio communication standard; in particular, the UMTS standard.

### BACKGROUND OF THE INVENTION

The present invention relates to a method for secure establishment of a communication connection, as well as to a communication terminal device for secure establishment of a communication connection.

There are methods known via which data can be transferred securely over communication networks. “Securely”, in this context, means that communication subscribers of the communication network can be confident with a high level of probability that received data:

1) has not been read on the transmission path by someone unauthorized;

2) has not been modified on the transmission path; and

3) has been received from the person who purports to have sent the data.

The techniques used to safeguard these three basic principles of secure data transfer are called:

1) ciphering (or encryption);

2) integrity checking; and

3) authentication.

Basically, the methods used for encryption and authentication are subdivided into two groups as follows:

1) methods in which the keys for encryption and decryption are identical (so-called symmetric or “secret key” methods); and

2) methods in which different keys are used for encryption and decryption (so-called asymmetric or “public key” methods in which a private key and a public key (i.e., a key pair), are generated for each entity to be made secure).

With symmetric methods, the algorithm for encryption or decryption is generally known and for effective encryption it is important to keep the key secret. With asymmetric methods, the algorithm likewise is generally known and for effective encryption it is important to keep the private key secret, while the public key may be generally known.

If two communication terminal devices that wish to use one of the above-mentioned methods, and that run the same algorithm for this method, have exchanged a suitable key and if this key is known to no one (to no unauthorized entity), the encryption algorithm ensures adequate encryption and authentication or an adequate integrity check.

Extremely secure communication can be guaranteed in communication networks of a type in which, as described, algorithms are used to ensure transmission security and in which the keys are already known to the communicating entities before the start of the data communication.

On the other hand, in networks in which the keys first of all must be negotiated before the data transfer, this key negotiation phase represents an opportunity for unauthorized communication entities to obtain or manipulate the keys and thereby corrupt the secure data transfer.

In particular, with the kind of data transfers in which the communication entities (communication terminal devices) initially have no knowledge of each other, in which therefore they also have no keys or common unpublished secret data, it is necessary at the beginning of the data transfer to exchange messages which are largely unencrypted and, therefore, may be exposed to an attack by unauthorized third parties. Such third parties possibly then may listen in to the key negotiation and in this way come into possession of the keys, or they interpose themselves between the communication entities and to each of them make themselves out to be the other communication entity (“man in the middle”). In this way, they are able to intercept the communication between the two entities.

An object to which the present invention is directed is to provide a method and a communication terminal device which permit unauthorized accesses to data transferred within a communication network to be excluded to the greatest possible extent.

### SUMMARY OF THE INVENTION

In the method according to the present invention for secure establishment of a direct communication connection operating according to a first communication standard between at least a first communication terminal device and a second communication terminal device. For establishment of the direct communication connection according to the first communication standard, an exchange of keys for encrypting data transferred over the direct communication connection is carried out, and the key exchange is performed at least partially via a further switched communication connection operating according to a radio communication standard; in particular, the UMTS standard.

The method according to the present invention additionally has the advantage that it can be used in all communication systems in which terminal devices communicate with one another directly or at least over an insecure communication network; for example, wireless devices, DECT devices, WLAN or LAN communication or also UMTS mobile radio devices in so-called “direct mode” (a terminal device to terminal device communication without mobile radio network which represents a possible extension of the UMTS standard for the future since at least parts of the keys reach the communication partners via a secure transmission path).

The key exchange is preferably performed following the reception of a first message transmitted by the second communication terminal device at the first communication terminal device, wherein for this purpose the first message, structured in the form of a “request,” contains address information uniquely authenticating a second communication terminal device in a network configured according to the radio communication standard. As such, it is clear that the request for establishment of the direct communication connection is detected and, as a result of the transfer of the address information, it is ensured that only the communication partner configured according to the radio communication standard is authenticated and able to receive data over the switched communication path.

If a second message containing a first key is transmitted by the first communication terminal device to the second communication terminal device via the switched communication connection, and subsequently a third message containing a second key is transmitted by the second communication terminal device to the first communication terminal device via the direct communication connection, at least the transfer of the first key is secure. Therefore, at least the manipulation or corruption of data transmitted by the second communication terminal device to the first communication terminal device is largely excluded. This variant takes into account the effect that in order for the transferred data to be misused, generally both transmission directions need to be tapped and, above all, decrypted. If at least one transmission direction is secure before interception of the key and, consequently, before the tapping, it is difficult for an unauthorized third party to comprehend the context of the exchanged data. A “man in the middle” attack therefore is not possible.

In an advantageous embodiment, not only does the first communication terminal device transmit a second message containing a first key to the communication terminal device, but the second communication terminal device also transmits a third message containing a second key to the first communication terminal device via the switched communication connection, with the result that the keys for both transmission directions are protected against interception.

If the second message is used to transfer, in addition to the first key, a bit sequence, particularly a randomly generated one, to the second communication device via the switched communication connection, this has the advantage that the first communication terminal device creates a way of authentication based on a bit sequence which only it knows. To protect against deciphering by unauthorized third parties, the bit sequence received by the second terminal device is advantageously transferred encrypted with the first key of the second communication terminal device via the direct communication connection as part of the third message, with the result that the bit sequence of the second message can be compared with the bit sequence of the third message in the first communication terminal device, the result of the comparison providing information about the authentication. If the two sequences match, it is clear that the source of the third message can only be the second communication terminal device, so that finally the desired data exchange between the first communication terminal device and second communication terminal device can take place by a direct path; i.e., over the direct communication connection. To this end, data originating from the first communication terminal device is encrypted with the second key and the data originating from the second communication terminal device is encrypted with the first key, with the result that unauthorized evaluation of the transferred data is prevented.

If the transmission of the second and/or third message operates according to a standard for short messages transmitted via radio, particularly according to the “Short Message Standard,” the method is easily implemented using existing one-way messaging methods.

Alternatively, the transmission of the second and/or third message can be implemented according to a standard for transmission of packet data, with the result that the method according to the present invention can be implemented, for example, in systems without comparable one-way messaging methods.

In an embodiment, a communication terminal device is provided for secure establishment of a direct communication connection which enables an implementation of the method by providing parts for performing the method.

Additional features and advantages of the present invention are described in, and will be apparent from, the following Detailed Description of the Invention and the Figures.

### BRIEF DESCRIPTION OF THE FIGURES

FIG. 1 shows an arrangement to which the inventive method and communication terminal device are directed.

FIG. 2 shows a schematic representation of the sequence of the method according to the present invention when used in an arrangement as shown in FIG. 1.

### DETAILED DESCRIPTION OF THE INVENTION

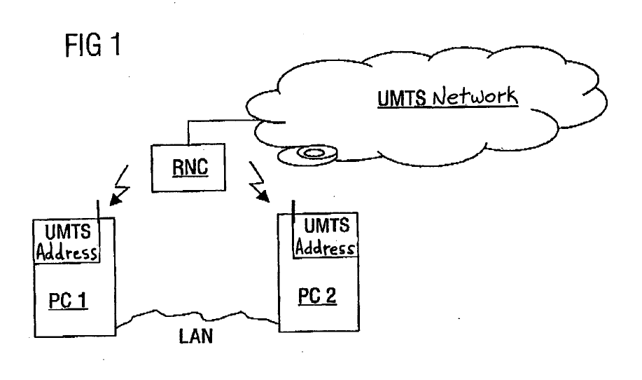

In the example shown in FIG. 1, a first communication terminal device PC1 and a second communication terminal device PC2, which in this exemplary embodiment are both respectively implemented as a data processing terminal device, such as a personal computer (PC) or laptop, each having a UMTS PC card (UMTS1, UMTS2).

With the aid of these UMTS PC cards UMTS1, UMTS2, the first communication terminal device PC1 and the second communication terminal device PC2 are able to transfer data wirelessly to a radio coverage area provided by a UMTS mobile radio network UMTS-NETWORK. The UMTS mobile radio network UMTS-NETWORK is shown in simplified form for this representation by UMTS air interfaces (arrows) and a radio network controller (RNC) which controls the air interfaces.

Between the two communication terminal devices PC1, PC2 according to the exemplary embodiment there exists a common connection to a further communication network LAN. Via this network LAN, configured as a so-called “local area network,” the first communication terminal device PC1 and the second communication terminal device PC2 are able to set up a direct connection to each other. Direct, in this context, refers to a communication connection being able to be established and data exchanged over it without switching by a higher-ranking entity, such an entity in wireless networks being comparable with a base station.

Alternatively, the present invention also can be implemented using mobile terminal devices, such as UMTS terminal devices, which are capable of establishing a direct connection in a so-called “direct mode,” or using “Digital European Cordless Telephones” DECT terminal devices in a comparable “direct mode,” but it is not restricted to this. It would, for example, be possible to use the Bluetooth short-range radio standard for implementing a direct connection.

For this exemplary embodiment, without being restricted to this, the UMTS network has been chosen as the radio communication network since it enables secure communication between two subscribers. Comparably secure radio communication networks likewise would be usable.

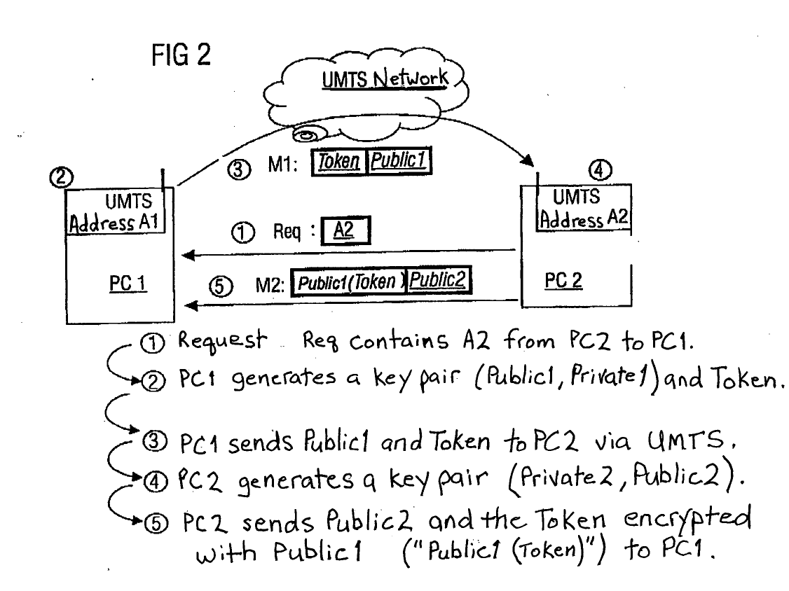

The sequence according to the present invention for establishing a secure direct connection in the scenario illustrated above is shown in FIG. 2.

A noteable feature of the method according to the present invention is that the two communication terminal devices also have the ability, in addition to the direct communication connection to be established via the local area network LAN, to communicate via a secure radio communication network, such as the UMTS mobile radio network UMTS-NETWORK, in which case each of the terminal devices advantageously are assigned a unique address within the relevant radio communication network UMTS-NETWORK.

The inventive method comes into its own in situations where, for example, the second communication terminal device PC2 determines that it would like to establish a secure communication link to the first communication terminal device PC1.

A possible scenario is, for example, that the first communication terminal device PC1 is a server on the Internet which, for example, supports the Internet sales of a company.

The second communication terminal device PC2 could be, for example, the personal computer of a user who would like to purchase the products of this company over the Internet. To this end, the user checks out the homepage of the company and there sees the telephone number A1 (MS-ISDN) of the server which is to be used for electronic key negotiations (e.g., +491755815000).

The user can enter this telephone number either manually or automatically into a corresponding program of his/her terminal device PC2 which is to perform the encrypted communication according to the present invention.

The method according to the present invention now begins with a first step 1 in which the second communication terminal device PC2 composes a request message REQ which contains the telephone number A2 of the second terminal device PC2 in the UMTS network (MS-ISDN, for example +491755815099) and the request for a key, and sends this via the Internet LAN to the first communication terminal device PC1.

In a second step 2, the first communication terminal device PC1 receives this message, generates a key pair consisting of a private 128-bit long first key PRIVATE1 and a public 128-bit long second key PUBLIC1. Furthermore, the first terminal device generates a 32-bit long random bit sequence TOKEN.

In a third step 3, the random sequence TOKEN and the second key PUBLIC1 are transmitted in a first message M1, which is structured according to the “Short Message Service (SMS)” known from the “Global System Mobile” GSM and UMTS standard, via the UMTS mobile radio network UMTS-NETWORK to the second communication terminal device PC2.

In a fourth step 4, the second communication terminal device PC2 receives this SMS and compares the sender call number A1 with the call number from the Internet (in this case +491755815000). If these match, the sender of the SMS is authenticated, with the result that in this fourth step 4 the second communication terminal device PC2, in turn, generates a key pair with a private 128-bit long third key PRIVATE2 and a public 128-bit long fourth key PUBLIC2 and composes a second message M2.

In a fifth step 5, the second message M2, which contains the fourth key PUBLIC2 together with the previously received random sequence TOKEN which was previously encrypted with the second key PUBLIC1, is transferred to the first terminal device PC1 via the direct communication connection provided by the Internet.

After reception of the second message M2, the random sequence TOKEN contained therein can be decrypted by the first communication terminal device PC1 with the aid of the first key PRIVATE 1 in order to authenticate the sender of the second message M2 by comparison with the previously transmitted random sequence TOKEN.

If these sequences match, the desired direct communication connection between the first communication terminal device PC1 and the second communication terminal device PC2 can be securely established since, upon completion of the method according to the present invention, as well as the authentication of the source PC1, PC2, the negotiated keys PUBLIC1, PUBLIC2 for an encryption of the direct communication connection between the first terminal device PC1 and the second terminal device PC2 are also available at the respective communication partner.

The present invention is not to be restricted to the exemplary embodiment described. To the contrary, it also covers the application, in all communication systems in which terminal devices communicate with one another directly or at least via an insecure communication network, such as, for example, radio devices, DECT devices, devices designed for WLAN communication or also UMTS mobile radio devices in so-called “direct mode” of a terminal device to terminal device communication without mobile radio network, which represents a possible extension of the UMTS standard for the future, provided the basic method of the present invention (at least partial key exchange for a communication via a communication connection which operates according to a secure radio communication standard) is implemented.

Indeed, although the present invention has been described with reference to an exemplary embodiment, those of skill in the art will recognize that changes may be made thereto without departing from the spirit and scope of the present invention as set forth in the hereafter appended claims.

1. A method for secure establishment of a direct communication connection between at least a first communication terminal device and a second communication terminal device, the method comprising:
providing that the direct communication connection operate according to a first communication standard;
providing a switched communication connection operating according to a radio communication standard between the first communication terminal device and the second communication terminal device; and
effecting an exchange of keys between the first and second communication terminal devices for encrypting data transferred over the direct communication connection, wherein the exchange of keys is at least partially performed via the switched communication connection.

2. A method for secure establishment of a direct communication connection between at least a first communication terminal device and a second communication terminal device as claimed in claim 1, wherein the radio communication standard is a UMTS standard.

3. A method for secure establishment of a direct communication connection between at least a first communication terminal device and a second communication terminal device as claimed in claim 1, further comprising transmitting a first message, as a request, from the second communication terminal device to the first communication terminal device, prior to the exchange of keys, wherein the first message contains address information uniquely authenticating the second communication terminal device in a network configured according to the radio communication standard.

4. A method for secure establishment of a direct communication connection between at least a first communication terminal device and a second communication terminal device as claimed in claim 3, further comprising:
transmitting a second message from the first communication terminal device to the second communication terminal device via the switched communication connection, wherein the second message contains a first key; and
transmitting a third message from the second communication terminal device to the first communication terminal device via one of the direct communication connection and the switched communication connection, wherein the third message contains a second key.

5. A method for secure establishment of a direct communication connection between at least a first communication terminal device and a second communication terminal device as claimed in claim 4, the method further comprising:
transmitting a randomly generated bit sequence, as part of the second message, from the first communication device to the second communication device via the switched communication connection;
encrypting the bit sequence with the first key in the second communication terminal device;
transmitting the encrypted bit sequence, as part of the third message, from the second communication terminal device to the first communication terminal device via one of the direct communication connection and the switched communication connection;
comparing the bit sequence of the second message with the encrypted bit sequence of the third message in the first communication terminal device; and
effecting a data exchange between the first communication terminal device and the second communication terminal device, if the bit sequence of the second message matches the encrypted bit sequence of the third message, via the direct communication connection, wherein data originating from the first communication terminal device is encrypted with the second key and data originating from the second communication device is encrypted with the first key.

6. A method for secure establishment of a direct communication connection between at least a first communication terminal device and a second communication terminal device as claimed in claim 4, wherein the transmission of at least one of the second message and the third message operates according to a standard for short messages transmitted via radio.

7. A method for secure establishment of a direct communication connection between at least a first communication terminal device and a second communication terminal device as claimed in claim 5, wherein the transmission of at least one of the second message and the third message operates according to a standard for short messages transmitted via radio.

8. A method for secure establishment of a direct communication connection between at least a first communication terminal device and a second communication terminal device as claimed in claim 4, wherein the transmission of at least one of the second message and the third message operates according to a standard for transmitting packet data.

9. A method for secure establishment of a direct communication connection between at least a first communication terminal device and a second communication terminal device as claimed in claim 5, wherein the transmission of at least one of the second message and the third message operates according to a standard for transmitting packet data.

10. A communication terminal device for secure establishment of a direct communication connection with a further communication terminal device, the direct communication connection operating according to a first communication standard, comprising:
parts for effecting an exchange of keys between the communication terminal device and the further communication terminal device for encrypting data transferred over the direct communication connection; and
parts for ensuring that the exchange of keys is at least partially performed via a switched communication connection operating according to a radio communication standard.

11. A communication terminal device as claimed in claim 10, wherein the radio communication standard is a UMTS standard.

12. A communication terminal device as claimed in claim 10, further comprising parts for receiving a first message, as a request, transmitted by the further communication terminal device, the first message containing address information uniquely authenticating the second communication terminal device in a network configured according to the radio communication standard, and wherein the exchange of keys is performed following reception of the first message.

13. A communication terminal device as claimed in claim 12, further comprising:
parts for transmitting a second message containing a first key to the further communication terminal device via the switched communication connection; and
parts for receiving a third message containing a second key transmitted by the further communication terminal device via one of the direct communication connection and the switched communication connection.

14. A communication terminal device as claimed in claim 13, further comprising:
parts for transmitting a randomly generated bit sequence, as part of the second message, to the further communication terminal device via the switched communication connection;
parts for receiving a bit sequence, as part of the third message encrypted with the first key in the further communication terminal device, transmitted by the further communication terminal device via one of the direct communication connection and the switched communication connection;
parts for comparing the bit sequence of the second message with the encrypted bit sequence of the third message; and
parts for effecting a data exchange, if the bit sequence of the second message matches the encrypted bit sequence of the third message, between the communication terminal device and the further communication terminal device via the direct communication connection, wherein data originating from the communication terminal device is encrypted with the second key and data originating from the further communication terminal device is encrypted with the first key.

15. A communication terminal device as claimed in claim 13, wherein the transmission of at least one of the second message and the third message operates according to a standard for short messages transmitted via radio.

16. A communication terminal device as claimed in claim 14, wherein the transmission of at least one of the second message and the third message operates according to a standard for short messages transmitted via radio.

17. A communication terminal device as claimed in claim 13, wherein the transmission of at least one of the second message and the third message operates according to a standard for transmitting packet data.

18. A communication terminal device as claimed in claim 14, wherein the transmission of at least one of the second message and the third message operates according to a standard for transmitting packet data.
